(19) United States
(12) Patent Application Publication
(10) Pub. No.: US 2021/0055909 A1
(43) Pub. Date: Feb. 25, 2021

(54) SYSTEMS AND METHODS FOR VOICE ACTIVATED INTERFACE

(71) Applicant: VISA INTERNATIONAL SERVICE ASSOCIATION, SAN FRANCISCO, CA (US)

(72) Inventors: Uzair Rahim, Austin, TX (US); Arif Pathan, Austin, TX (US)

(21) Appl. No.: 16/544,486

(22) Filed: Aug. 19, 2019

(51) Int. Cl. G06F 3/16; G06F 3/0481; G10L 15/22; G10L 15/08

(52) U.S. Cl. CPC G06F 3/167; G06F 3/0481; G10L 2015/088; G10L 15/08; G10L 2015/223; G10L 15/22

(57) ABSTRACT

A computer-implemented method comprising providing a web portal including one or more web applications and receiving a user voice command. The method includes querying a command database for words in a command transcription of the user voice command, matching the words of the user voice command with a command word of the command words, and executing an action associated with the command.

### FIELD

The disclosure relates to systems and methods voice activated interfaces.

### BACKGROUND

Software applications such as web applications, mobile applications, cloud applications, etc., may have limited space on which to display data and other functional features. Applications may often need to display content in a way that is accessible, usable, and effective, but also provide space for hyperlinks, buttons, icons, or other selectable features to enable different parts of the application. Often, important action items for an application may be buried or hidden from view due to limited display space, or the display of data or other graphical features is restricted in service of making those action items visible.

### BRIEF DESCRIPTION OF THE DRAWINGS

The disclosure may be better understood by references to the detailed description when considered in connection with the accompanying drawings. The components in the figures are not necessarily to scale, emphasis instead being placed upon illustrating the principles of the disclosure. In the figures, like reference numerals designate corresponding parts throughout the different views.

FIG. 1 is an illustration of the elements of an embodiment of a computer system that includes a voice activation system as shown and described herein;

FIG. 2 is a schematic illustration of elements of an embodiment of an example computing device;

FIG. 3 is a schematic illustration of elements of an embodiment of an example server type computing device;

FIG. 4 is a flow chart of an embodiment of a method for using the voice activation system as shown and described herein;

FIG. 5 is a flow chart of an embodiment of another method for using the voice activation system as shown and described herein;

FIG. 6 is a an embodiment of a user interface of a web application operating the voice activation system shown and described herein;

FIG. 7 is a an embodiment of a user interface of a web portal operating the voice activation system shown and described herein; and

FIG. 8 is an exemplary user interface for a voice activation toolkit of the voice activation system as shown and described herein.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In embodiments, the disclosure describes providing a voice activation system that may be used to execute actions within a web application. In some embodiments, the selectable actions may be hidden from immediate view, providing for more efficient access to application functionality without cluttering limited space on a display screen.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. These illustrations and exemplary embodiments are presented with the understanding that the present disclosure is not intended to limit any one of the embodiments illustrated. The disclosure may be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

An interface of an application, such as a web application, may be limited in display space based on the size of a device's display screen. The limited display space limits the amount of data, graphics, functionality, or other features that may be displayed to a user. Accordingly, certain action items may be hidden in menus, links, scrolling, etc., in order to provide adequate space for other features or data. Application designers may be forced to choose between hiding actionable items such as links, buttons, icons, etc., in inconvenient locations in order to prioritize other data or features on the limited display space, or to include those action items on the limited display space but sacrifice the display of important data or application functionality.

At a high level, the disclosure describes a voice activated user interface (UI) system and method of using such system that may help declutter the application's user interface by removing one or more actionable items like links, buttons, icons, etc., and allowing a user to activate those items via voice commands. Removing some or all actionable items from the display screen may free up important screen real estate to display additional data, graphics, or functionality. In some embodiments, a user may be able to select actions by speaking user commands into a microphone included in a user computing device. The spoken user command may be transcribed to text, for example, with a voice processor or a remote voice processor service. The transcribed text may then be processed to recognize command words that may correspond to actions available to the user via the web application. For example, the user may issue a voice command to “Search for Richard's Clothing Store.” In response, the system may execute a search command for Richard's Clothing Store in the web application. In some embodiments, the system may receive and process voice commands for major actions in a single, displayed web interface via hyperlinks, etc. In some embodiments, the system may receive and process voice commands for any action item or hyperlink in any web interface. In some embodiments, the system may receive and process voice commands for actions that may be accessible via any of a variety of interfaces through a portal or application.

In some embodiments, the disclosure describes a computer-implemented method that may comprise providing a web application interface including one or more hyperlinks, and receiving a list of one or more command words. Each of the one or more command words may be associated with activating at least one hyperlink of the one or more hyperlinks. The method may include receiving an audio command stream, where the audio command stream may be an audio recording of a user command to select a hyperlink of the one or more hyperlinks. The method may include transmitting the audio command stream to a speech recognition application programming interface (API), and receiving a command transcription of the user command from the speech recognition API. The command transcription may include one or more words of the user command. The method may include identifying at least one command word of the one or more command words in the command transcription. Based on the identification of the at least one of the one or more command words, the method may include executing a selected hyperlink of the one or more hyperlinks, where the selected hyperlink may be associated with the at least one command word.

In some embodiments, the disclosure describes a computer-implemented method that may comprise providing a web application interface including one or more hyperlinks. The method may include receiving a list of one or more command words, where the one or more command words may include a first command word associated with a first hyperlink and a second command word associated with a second hyperlink. The method may include receiving an audio command from a user, where the audio command stream may be an audio recording of a user command to select a hyperlink of the one or more hyperlinks. The method may include transmitting the audio command stream to a speech recognition application programming interface (API), and receiving a command transcription of the user command from the speech recognition API. The command transcription may include one or more words of the user command, and identifying at least one of the first command word or the second command word in the command transcription. The method may also include executing the first hyperlink when the first command word is identified and executing the second hyperlink when the second command word is identified.

In some embodiments, the disclosure describes a computer-implemented method that may comprise providing a web portal including one or more web applications. The method may include receiving an audio command stream, where the audio command stream may be an audio recording of a user command. The method may include querying a command database for at least one word of a command transcription of the user command, where the command database may include a plurality of commands each associated with one or more command words and each associated with an action. The method may include matching the at least one word of the user command with a command word of the one or more command words associated with a command of the plurality of commands. Based on the matching of the at least one word of the user command with the command word of the one or more command words, the method may include executing an action associated with the command.

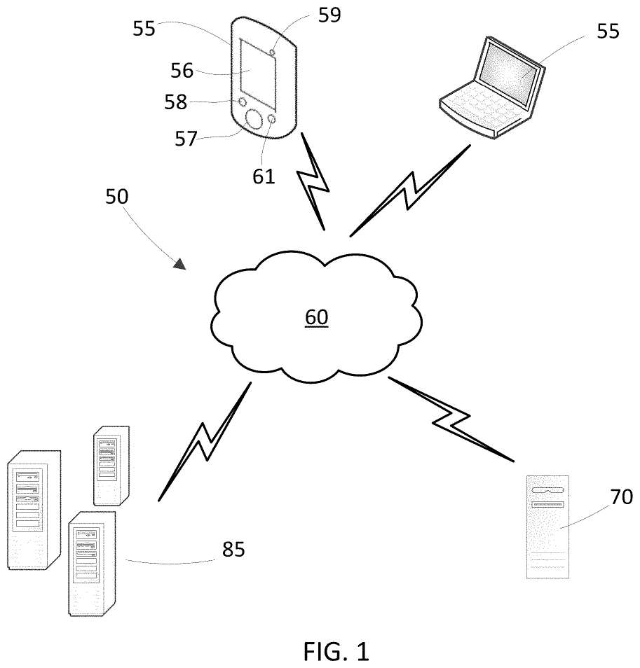

A high level illustration of some of the elements in a sample computing system 50 that may be physically configured to implement the voice activation system and process is illustrated in FIG. 1. The system 50 may include any number of computing devices 55, such as smart phones or tablet computers, mobile computing devices, wearable mobile devices, desktop computers, laptop computers, or any other computing devices that allow users to interface with a digital communications network, such as digital communication network 60. Connection to the digital communication network 60 may be wired or wireless, and may be via the internet or via a cellular network or any other suitable connection service. Various other computer servers may also be connected via the digital communication network 60, such as one or more application servers 70 and a speech recognition server 85. The speech recognition server 85 may represent, for example, a cloud computing service, a speech-to-text service such as Google® Cloud Speech-to-Text.

In one embodiment, the computing device 55 may be a device that operates using a portable power source, such as a battery. The computing device 55 may also have a display 56 which may or may not be a touch sensitive display. More specifically, the display 56 may have a capacitance sensor, for example, that may be used to provide input data to the computing device 55. In other embodiments, an input pad 57 such as arrows, scroll wheels, keyboards, etc., may be used to provide inputs to the computing device 55. In addition, the computing device 55 may have a microphone 58 which may accept and store verbal data, a camera 59 to accept images and a speaker 61 to communicate sounds.

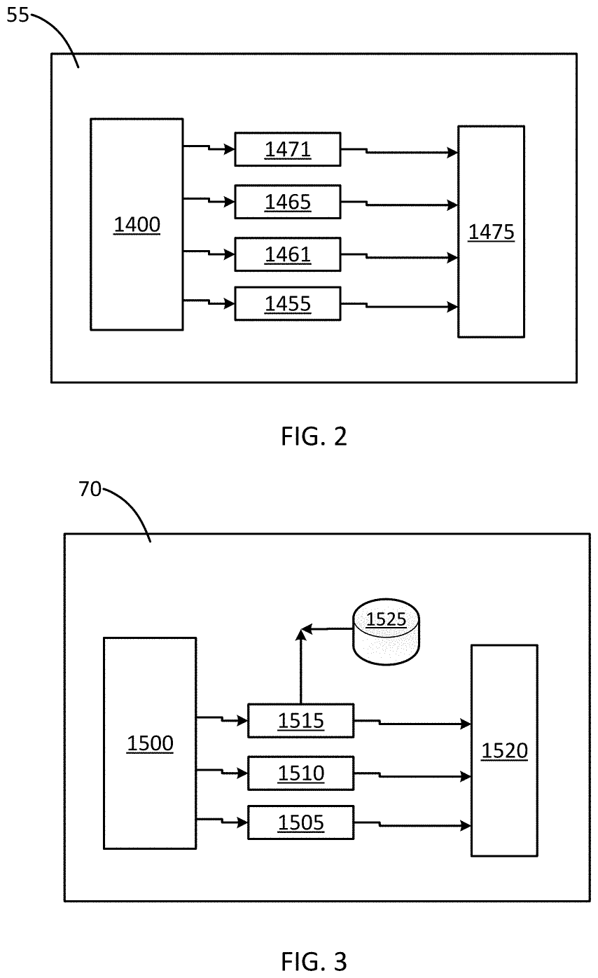

FIG. 2 is a simplified illustration of the physical elements that make up an embodiment of a computing device 55 and FIG. 3 is a simplified illustration of the physical elements that make up an embodiment of a server type computing device, such as the application server 70, but the speech recognition server 85 may reflect similar physical elements in some embodiments. Referring to FIG. 2, a sample computing device 55 is illustrated that is physically configured according to be part of the computing system 50 shown in FIG. 1. The portable computing device 55 may have a processor 1451 that is physically configured according to computer executable instructions. In some embodiments, the processor can be specially designed or configured to optimize communication between the server 70 and the computing device 55 relating to the health evaluation application described herein. The computing device 55 may have a portable power supply 1455 such as a battery, which may be rechargeable. It may also have a sound and video module 1461 which assists in displaying video and sound and may turn off when not in use to conserve power and battery life. The computing device 55 may also have volatile memory 1465 and non-volatile memory 1471. The computing device 55 may have GPS capabilities that may be a separate circuit or may be part of the processor 1451. There also may be an input/output bus 1475 that shuttles data to and from the various user input/output devices such as a microphone, a camera 59, a display 56, or other input/output devices. The portable computing device 55 also may control communicating with the networks, such as communication network 60 in FIG. 1, either through wireless or wired devices. Of course, this is just one embodiment of the portable computing device 55 and the number and types of portable computing devices 55 is limited only by the imagination.

The physical elements that make up an embodiment of a server, such as the application server 70, are further illustrated in FIG. 3. In some embodiments, the speech recognition server is specially configured to run the voice activation system as described herein. At a high level, the application server 70 may include a digital storage such as a magnetic disk, an optical disk, flash storage, non-volatile storage, etc. Structured data may be stored in the digital storage such as in a database. More specifically, the server 70 may have a processor 1500 that is physically configured according to computer executable instructions. In some embodiments, the processor 1500 can be specially designed or configured to optimize communication between a portable computing device, such as computing device 55, and the server 85 relating to the voice activation system as described herein. The server 70 may also have a sound and video module 1505 which assists in displaying video and sound and may turn off when not in use to conserve power and battery life. The server 70 may also have volatile memory 1510 and non-volatile memory 1515.

A database 1525 for digitally storing structured data may be stored in the memory 1510 or 1515 or may be separate. The database 1525 may also be part of a cloud of servers and may be stored in a distributed manner across a plurality of servers. There also may be an input/output bus 1520 that shuttles data to and from the various user input devices such as a microphone, a camera, a display monitor or screen, etc. The input/output bus 1520 also may control communicating with the networks, such as communication network 60, either through wireless or wired devices. In some embodiments, a voice activation controller for running the health evaluation application may be located on the computing device 55. However, in other embodiments, the voice activation controller may be located on speech recognition server 85, or both the computing device 55 and the server 70. Of course, this is just one embodiment of the speech recognition server 85 and additional types of servers are contemplated herein.

In the embodiment illustrated in FIG. 1, the speech recognition server 85 may be connected to the application server 70 either through the digital communication network 60 or through other connections. In some embodiments, the application server 70 may be associated with any type of company, organization, or other entity providing an application, web interface, web application, software portal, other software application, etc. The application server 70 or a group of servers may host the web application, mobile application, software application, etc.

In some embodiments, the voice activation system may be hosted on or otherwise run by the speech recognition server 85. In some embodiments, a user may access the speech recognition server 85 via a computing device 55 such as a smartphone, laptop computer, desktop computer, etc., and may set up an account with the voice activation system or a web application on which the voice activation system runs. The voice activation system may store information associated with the user into the user's account so that the system may recognize preferences and settings of the user.

The computing device 55 may be able to communicate with a computer server or a plurality servers, such as the one or more application servers 70. The computing device 55 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the server or may be through a digital communication network 60 such as cellular service, through the Internet, through a private network, through Bluetooth, etc.

In some embodiments, the application server or servers 70 may be associated with the voice activation system, and may send and receive information to and from a user device 55 associated with operating the voice activation system and/or a web application. Specifically, software may be included on the user computing device 55 allowing notifications to be received from the voice activation system via the digital communications network 60. In some embodiments, the software may be an application through which a user may use to interface with the application server or a web application hosted by the application server. In some embodiments, the software may be an add-on to a web browser included on the user computing device 55. In some embodiments, the voice activation system's software may be an application installed on the user computing device 55 that allows for the use of other applications on the user computing device. In yet other embodiments, the voice activation system may provide notifications using software native to the user computing device 55, such as SMS messaging or other notifications. In such embodiments, the voice activation system may send notifications to the user device 55.

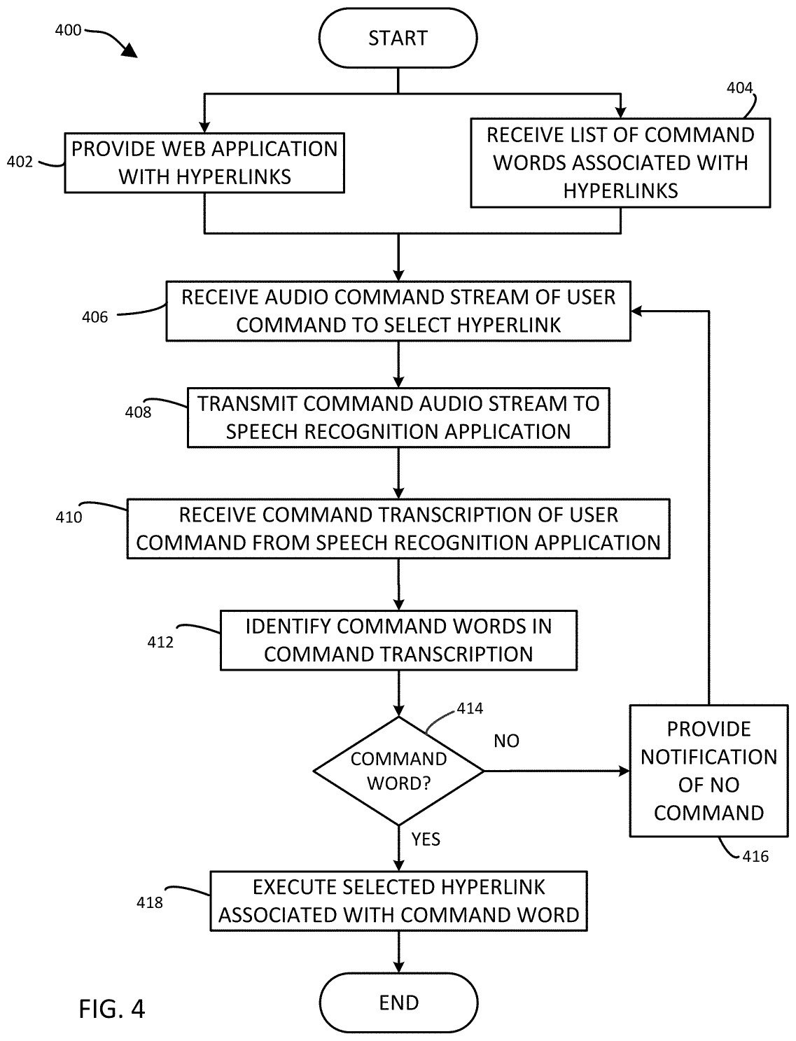

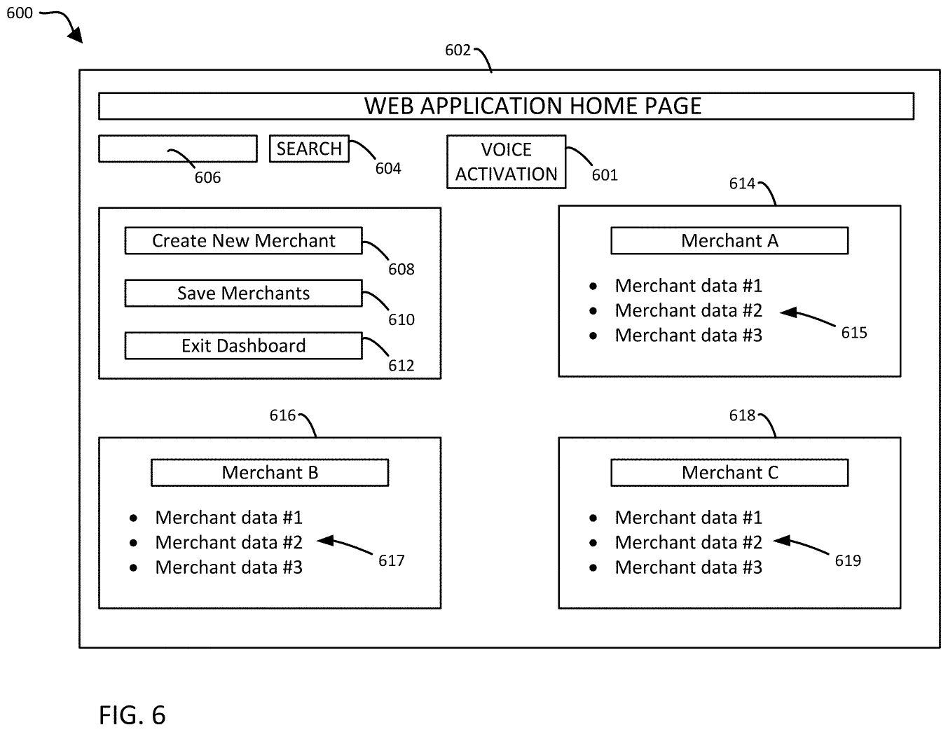

FIG. 4 is a flow chart of an embodiment a method 400 of using the voice activation system as described herein. At 402, the method may include providing a web application, such as via the application server 70, that may include a plurality of hyperlinks or other action items. For example, the web application may provide searching capabilities through a search box and search button, links to other application functionality, or icons activating features of the web application. An exemplary embodiment of a web application interface 600 that may implement the voice activation system described herein is shown in FIG. 6, described in greater detail below. It should be understood that other types of software applications may be used instead of or in addition to a web application, such as a mobile application stored and running on a portable computing device, or a native application stored and running on a laptop or desktop computing device. At 404, the method may include receiving a list of command words, each of which may be associated with activating at least one of the plurality of hyperlinks in the web application. In some embodiments, the list of command words may be in the form of a database, a text file, or any other suitable form. In some embodiments, the list of commands words may be received all at once, or incrementally over time with multiple lists or single command words added to the database or list. The command words may be stored in a command database, for example, on the application server 70 for later reference by the application server. In some embodiments, the command words may be supplied by an entity, such as a business or user providing the web application. In some embodiments, the command words may be determined automatically by, for example, identifying words in hyperlinks and the context of those words to determine the types of commands that may activate them. In some embodiments, the list of one or more command words may be received as a regular expression (e.g., regex or regexp).

At 406, the method may include receiving an audio command stream. In some embodiments, the audio command stream may be an audio recording of a user voice command. In some embodiments, the user command may have been captured via a user computing device, such as a microphone 58 of computing device 55 shown in FIG. 1. In some embodiments, the web application interface may include a voice trigger input icon that the user may select in order to activate the user voice command recording. In some embodiments, the a voice trigger input may alternatively or additionally include a voice trigger input keyboard shortcut using a keyboard input pad 57 of the computing device 55. In some embodiments, the voice activation system may be triggered simply by the user speaking a command, or speaking a specific trigger word to activate the system. In some embodiments, the audio command stream may be received at by the application server 70 as a discrete audio file including the entire command. In such embodiments, at 408, the application server 70 may transmit the command audio stream to a speech recognition application. In some embodiments, the speech recognition application may be run from the application server 70, or may be run from a remote server, such as the speech recognition server 85. In some embodiments, the audio command stream may be transmitted to the speech recognition application using a speech recognition application programming interface (API) (e.g., Google Cloud Speech-to-Text API). In some embodiments, the audio command stream may be received in “real time” as an audio stream. In other words, the audio command stream may be transmitted to the speech recognition application while a user is speaking so that transcription of the command may commence before the entire command is given for more immediate processing.

At 410, the method may include receiving a command transcription of the user voice command from the speech recognition application, for example, via the speech recognition API. In some embodiments, the command transcription may include a transcribed representation of one or more of the words that make up the user voice command. In other words, the command transcription may be a text representation of the spoken user voice command and may be stored in any suitable manner known to those skilled in the art. At 412, the method may include identifying at least one command word from the list of command words in the words that make up the command transcription. In some embodiments, this may include comparing the words in the command transcription to the list of one or more command words stored by the application server, such as in a command database. For example, the user voice command may include the phrase “open a new case,” which may be transcribed into text as the command transcription. The method may include identifying command words that match one or more of the words in that phrase, like “open” “new” “case,” for example. At 414, if no command words are recognized in the command transcription of the user command, the web application may, in some embodiments, provide a notification that no command was received at 416, and return to receiving voice commands. If one or more command words are identified in the words of the command transcription, the method may include, at 418, executing the selected hyperlink or other action associated with the one or more matched command words. For example, in the “open a new case” example, the voice activation system may match the word “open” and “new case” with a hyperlink on the web application that may open a new case and execute that hyperlink. In some embodiments, executing the selected hyperlink may include activating a hyperlink location associated with the selected hyperlink, such as a particular web page or interface within the web application. In some embodiments, activating the selected hyperlink may include executing another web application, or may include executing a search of the web application interface. In some embodiments, the selected hyperlink or other action may be located on the interface of the web application. In some embodiments, the selected action or hyperlink may be hidden within a menu of the web application interface, or accessible via another action or hyperlink. In some embodiments, the selected action may be within another web application altogether.

In some embodiments, the command transcription may be further analyzed via text analysis and natural language processing. Such analysis may identify verbs, nouns, proper nouns, etc., in the command transcription. The voice activation system may then identify whether the action described by the verbs identified in the command transcription may be performed on the provided entity (e.g., noun) using additional parameters (e.g., proper noun). For example, if the command transcription includes the words “create a new merchant called abc.com,” the system may identify the word “create” as a verb/action, the word “merchant” as the noun, and “abc.com” as the proper noun. The system may then determine whether the action “create” matches a command word, and whether the action associated with that command word may be performed on the action or other entity associated with the word “merchant.” If so, the system may also determine that the new merchant should be named “abc.com” based on the identification of the proper noun “abc.com.” Of course, this is merely one example of text analysis that may be used in the context of a command transcription, and others may be recognized as falling within the parameters of the disclosure. In some embodiments, natural language processing may be used to more accurately determine the intention of any particular user voice command even if the specific words of the command transcription may not exactly match command words of the command database. The process of natural language procession may be known to those skilled in the art.

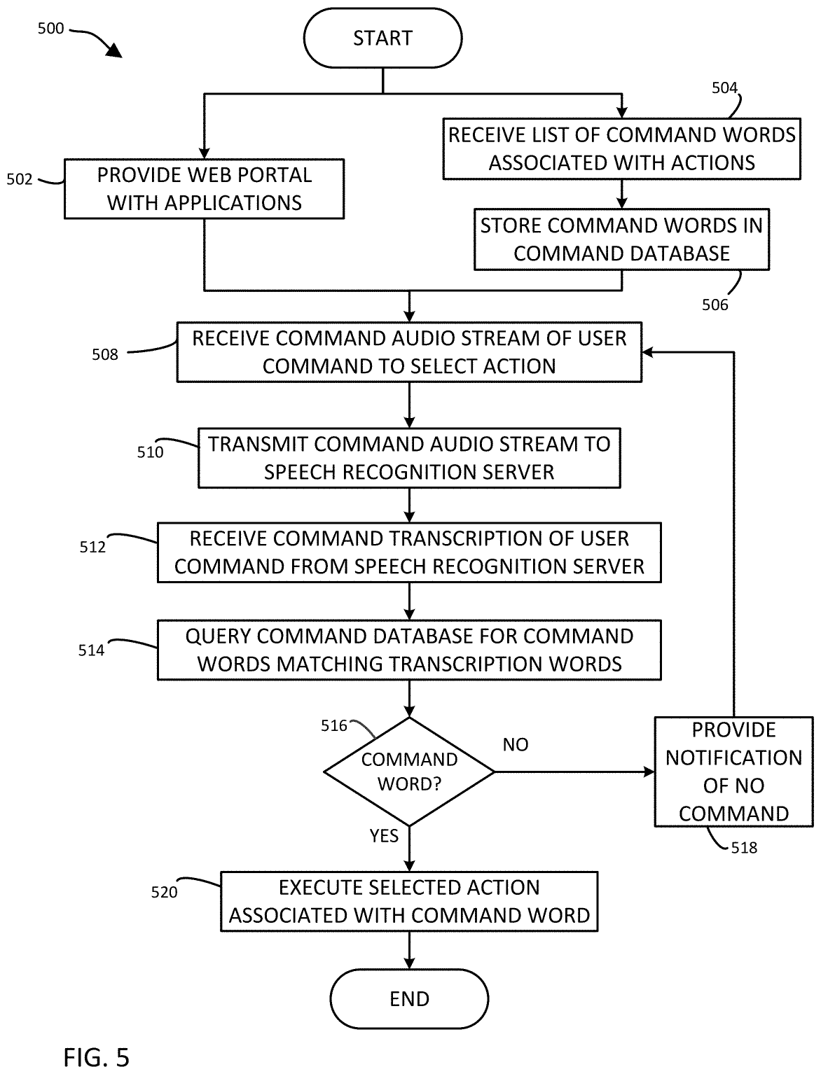

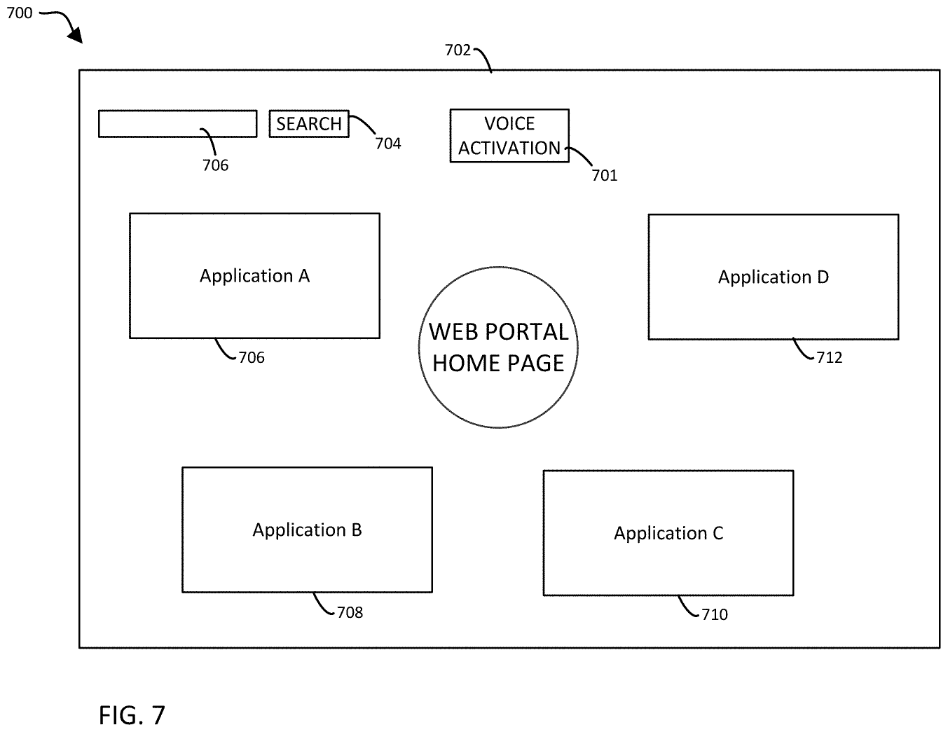

FIG. 5 is a flow chart showing another embodiment of a method 500 for using the voice activation system described herein. At 502, the method may include providing a web portal that may include access to one or more web applications. An exemplary web portal interface 700 is shown and described below in reference to FIG. 7. Each web application may be hosted on the application server, or may be hosted on other remote servers or as part of a cluster of application servers. At 504, the method may include receiving a list of one or more command words associated with actions, such as activating hyperlinks on the web portal or executing particular web applications. At 506, the command words may be stored in a command database, which may be located on the application server 70 or on a remote database server.

At 508, the method may include receiving an audio command stream. In some embodiments, the audio command stream may be an audio recording of a user voice command. In some embodiments, the user command may have been captured via a user computing device, such as a microphone 58 of computing device 55 shown in FIG. 1. In some embodiments, the audio command stream may be received at by the application server 70 as a discrete audio file including the entire command. In such embodiments, at 510, the application server 70 may transmit the command audio stream to a speech recognition application. In some embodiments, the speech recognition application may be run from the application server 70, or may be run from a remote server, such as the speech recognition server 85. In some embodiments, the audio command stream may be transmitted to the speech recognition application using a speech recognition application programming interface (API) (e.g., Google Cloud Speech-to-Text API). In some embodiments, the audio command stream may be received in “real time” as an audio stream. In other words, the audio command stream may be transmitted to the speech recognition application while a user is speaking so that transcription of the command may commence before the entire command is given for more immediate processing.

At 512, the method may include receiving a command transcription of the user voice command from the speech recognition application, for example, via the speech recognition API. In some embodiments, the command transcription may include a transcribed representation of one or more of the words that make up the user voice command. In other words, the command transcription may be a text representation of the spoken user voice command and may be stored in any suitable manner known to those skilled in the art. At 514, the method may include querying the command database for command words that may match words in the command transcription. At 516, if no command words are recognized in the command transcription of the user command, the web portal may, in some embodiments, provide a notification that no command was received at 518, and no action may be taken. If one or more command words from the command database are identified in the words of the command transcription, the method may include, at 520, executing the selected action associated with the one or more matched command words. In some embodiments, the selected action may be activating one or more of the web applications included in the web portal, or may include activating one or more actions or hyperlinks within one or more of the web applications accessible through the web portal. In some embodiments, the selected action or hyperlink may be hidden within a menu of the web portal interface, or accessible via another action or hyperlink.

FIG. 6 shows an example embodiment of a web application interface 600 that may use the voice activation system described herein. Of course, it should be understood that the web application interface 600 is merely an example and many other types of web application, application, or other interfaces may be used with the voice activation system. In some embodiments, the web application interface 600 may include a web application home page 602 that may display an interface to access various data and other actions. For example, the home page 602 may include a search bar 606 and search button 604, as well as various other action options such as create new merchant 608, save merchants 610, and exit dashboard 612. The application home page 602 may include preview dashboards for various merchants like Merchant A dashboard 614, Merchant B dashboard 616, and Merchant C dashboard 618. Each preview dashboard may include data related to the particular merchant, such as Merchant A data 615, Merchant B data 617, and Merchant C data 619. The application home page 602 may also include a voice trigger input icon 601 that may be selected by a user to activate the voice activation system.

Although the web application home page 602 includes various buttons, icons, and data, it may be that various other options or actions may not be visible from the home page, but may only be accessed through a pull down menu or through a series of user actions. For example, if a user wanted to search for a particular merchant that is not listed on the home page 602, the user may select the voice activation input icon 601, triggering the system to “listen” for the user voice command. The user may speak into the microphone the words “open Merchant D dashboard.” Even though Merchant D is not currently shown on the home page, the voice activation system may enable the user to execute a command to open a dashboard for Merchant D directly from the home page. In another example, the “Create New Merchant” button 608 may be a drop-down menu with various options, such as merchant type, location, etc. In some embodiments, the user may use a user voice command to select one of the options not visible on the homepage. In such embodiments, the home screen is able to remain less cluttered than would otherwise be necessary to display all such options for each merchant, for example.

FIG. 7 shows an example embodiment of a web portal interface 700 that may incorporate the voice activation system. Of course, it should be understood that the web portal interface 700 is merely an example and many other types of web portals, applications, or other interfaces may be used with the voice activation system. In some embodiments, the web portal interface 700 may include a web application portal page 702 that may display an interface to access various data and other actions, such as accessing one or more web applications associated with the web portal. For example, the home page 702 may include a search bar 706 and search button 704, as well as various other action options such as selecting Application A 706, Application B 708, Application C 710, or Application C 712. As with the web application interface 600, the web portal interface 700 may allow various actions that are hidden from view on the web portal home page 702 in order to declutter the display screen and increase efficiency of use. For example, the user may execute a search of a particular merchant within Application A by selecting the voice trigger input icon 701 and speaking the user voice command, “Search Merchant A in Application A.” In such embodiments, the user may execute Application A and conduct a search within that application without going through the steps of selecting Application A, selecting a search option within Application A, and executing the search. Additionally, the display is less cluttered for not needing to include all of such options onto the web portal home page 702.

In one example use of the voice activation system as described herein, a user may proceed through the following series of commands to activate a variety of actions through a web portal or web application related to a global investigation tool. In some embodiments, the actions activated by the commands may not have visible hyperlinks or icons on the interface:

User says, “Search for Richard's Clothing Store.” The system may invoke a Search API and returns the search results.

User says, “Select first item from the search results.” User may be redirected to a Merchant Profile for Richard's Clothing Store.

User says, “Create a case for this merchant.” User may be redirected to Create Case screen of the web application, such as for a Global Investigation Management Tool.

User says, “Save.” Case may be saved/created.

User says, “Take me back home.” User may be taken back to the home page of the web application or web portal, for example.

User says, “Show me Application A dashboard.” User may be redirected to the dashboard for Application A.

User says, “Show me investigator dashboard.” User may be redirected to Investigator Dashboard of the Global Investigation Management Tool.

User says, “Show me my cases.” User may be redirected to My Cases screen of Global Investigation Management Tool.

Users says, “Log Out.” User may be logged out of the application.

In some embodiments, a toolkit may be provided for setting up a voice activation system compatible with substantially any web application, website, mobile application, etc. The toolkit may include a user interface to collect information relating to the actions, hyperlinks, icons, etc., that the user would like to be selectable using voice activation. The toolkit may also receive or generate command words that may be associated with the particular actions or hyperlinks that the particular web application may include. In some embodiments, the toolkit may automatically process the possible selectable actions in a web application, generate command words associated with those actions, and store those command words in a database for reference during voice activation. In some embodiments, the toolkit may be configurable to apply to a single web page, to specific web pages or components of a web application, or the entire web application.

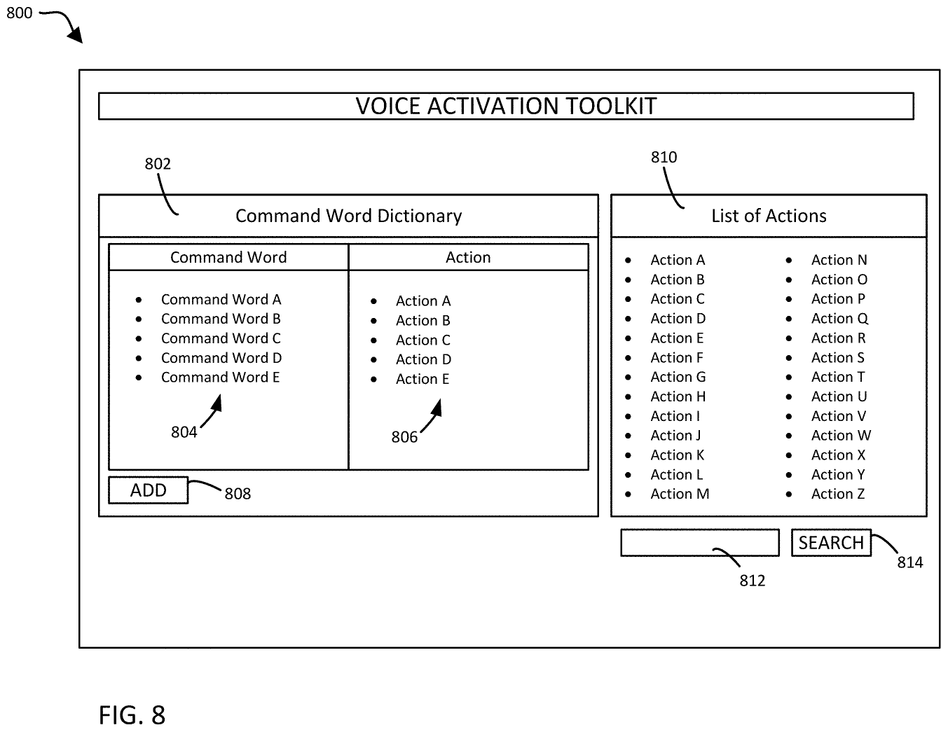

FIG. 8 shows an example embodiment of a toolkit user interface 800 that may be used to apply the voice activation system to a web application or other website or application. The interface 800 may include a command word dictionary 802 that may include a list 804 of the one or more command words matched to the respective actions 806 associated with each command word. In some embodiments, the interface 800 may include a list of actions 810 that may be executed by the particular web application or web portal. In some embodiments, the actions in the list of actions 810 may be automatically generated by the voice activation toolkit based on the particular web application, or actions may be added manually in some embodiments. In some embodiments, the actions in the list of actions 810 may be any action that may be executed within a web application via the web application interface, such as selecting hyperlinks, pressing graphical buttons, executing searches, opening menus, selecting hidden links within menus, opening other applications, etc.

The interface 800 may include an add button 808 that may allow a user to add a command word to the command word dictionary. Once the user has added a command word, the toolkit may request that the user select the action for which the command word should be associated. In some embodiments, the interface 800 may include a search box 812 and search button 814 to search the list of actions 810 available to be associated with a particular command word. The associated action may then be added automatically to the action list 806 adjacent the associated command word. In some embodiments, the toolkit may alternatively or additionally receive a selection of an action in the list of actions 810 and request that the user provide the command word to be associated with the selected action. It should be understood that, in some embodiments, the command word dictionary 802 may not include each and every word that the voice activation system may recognize to execute a particular action. In some embodiments, the voice activation system may automatically or be pre-programmed to automatically recognize common verbs or nouns that may be used in a web application, such as “search”, “save”, “open”, etc. Those skilled in the art will recognize that other common terminology applicable across many web applications may be included.

In some embodiments, the voice activation toolkit of the voice activation system may use machine learning techniques to automatically detect and identify certain command words predicted to be useful for a particular web application or other software for which the toolkit is being implemented. For example, the voice activation system may identify other web applications that have included similar actions and recommend certain command words that may be used for similar actions in the current web application. In some embodiments, the command word dictionary may include a preliminary list of command words suggested by the voice activation system, either because the command words are common or have been identified using machine learning. A user may then use the toolkit to customize and expand upon the command word dictionary. In some embodiments, it is contemplated that the toolkit may automatically generated and suggest command words for some or all of the actions in the list of actions 810 that a user may review or edit as desired.

In some embodiments, once the toolkit has been populated with one or more command words, the voice activation system and toolkit may rearrange the particular web application interface to more efficiently organize the limited space on a display screen. For example, a particular web application interface may include ten hyperlinks that may have been visible on before applying the voice activation toolkit. The user may then add command words associated with five of the ten hyperlinks on the web application interface. In response, the voice activation system may remove the five hyperlinks with associated command words from the web application interface to declutter the display screen. Of course, in some embodiments, more or fewer hyperlinks or other actions may be removed or moved. In some embodiments, the system may hide the removed hyperlinks in a menu to allow access if, for example, a user is unable to make voice commands. In some embodiments, the web application may be rearranged automatically in view of the command word dictionary and associated actions. In some embodiments, the web application may be rearranged by the user. In some embodiments, the web application may be rearranged by a third party, or the entity operating the application server hosting the voice activation system.

Thus, the voice activation system may provide a technical solution to the technical problem of providing efficient functionality and accessibility to a web application, website, mobile application, etc., with limited space on a display screen. The system provides a technical solution to the problem by providing for voice activation of one or more actions within the web application or portal even if the particular action is not immediately visible on the interface. Accordingly, a practical application of the disclosure may be to provide users with more efficient and user-friendly access to various software features without cluttering the display screen or taking away from other application features.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++ or Perl using, for example, conventional or object-oriented techniques. In some examples, the at least one processor may be specifically programmed.

The software code may be stored as a series of instructions, or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

It may be understood that the present disclosure as described above can be implemented in the form of control logic using computer software in a modular or integrated manner. Based on the disclosure and teachings provided herein, a person of ordinary skill in the art may know and appreciate other ways and/or methods to implement the present disclosure using hardware and a combination of hardware and software.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure. A recitation of “a”, “an” or “the” is intended to mean “one or more” unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed (or physically configured) to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

The present disclosure provides a solution to the long-felt need described above. In particular, the and the methods described herein may be configured to provide access to software or web application features without cluttering a display screen. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer-implemented method comprising:
providing a web application interface including one or more hyperlinks, wherein at least one of the one or more hyperlinks is a hidden hyperlink having no visible and selectable representation displayed on the web application interface;
receiving a list of one or more command words, each of the one or more command words being associated with activating a hyperlink of the one or more hyperlinks;
receiving an audio command stream, the audio command stream being an audio recording of a user command to select a selected hyperlink of the one or more hyperlinks, wherein the selected hyperlink is the at least one hidden hyperlink;
transmitting the audio command stream to a speech recognition application programming interface (API);
receiving a command transcription of the user command from the speech recognition API, the command transcription including one or more words of the user command;
identifying at least one command word of the one or more command words in the command transcription; and
based on the identification of the at least one of the one or more command words, executing the hidden hyperlink of the one or more hyperlinks, the hidden hyperlink being associated with the at least one command word,
wherein the method is performed using one or more processors.

2. The method of claim 1, wherein the list of one or more command words is received as a regular expression.

3. The method of claim 1 further comprising activating a hyperlink location associated with the selected hyperlink.

4. The method of claim 1 further comprising receiving a voice trigger input via a voice trigger input icon in the web application interface.

5. (canceled)

6. The method of claim 1, wherein the selected hyperlink executes a web application.

7. The method of claim 1, wherein the selected hyperlink executes a search of the web application interface.

8. A computer-implemented method comprising:
providing a first web application interface configured to select one or more hyperlinks based on audio commands from a user, wherein at least one of the one or more hyperlinks is a hidden hyperlink included in a second web application interface and having no visual or selectable representation displayed on the first web application interface;
receiving a list of one or more command words, the one or more command words including a first command word associated with a first action and a second command word associated with a second action, wherein the first action is to select the hidden hyperlink;
receiving an audio command from the user, the audio command being an audio recording of a user command to perform a selected action of the one or more actions, wherein the selected action is the first action to select the hidden hyperlink;
transmitting the audio command to a speech recognition application programming interface (API);
receiving a command transcription of the user command from the speech recognition API, the command transcription including one or more words of the user command;
identifying at least one of the first command word or the second command word in the command transcription; and
executing the first action by selecting the hidden hyperlink in the second web application interface when the first command word is identified and executing the second action when the second command word is identified,
wherein the method is performed using one or more processors.

9. The method of claim 8, wherein the list of one or more command words is received as a regular expression.

10. (canceled)

11. The method of claim 8 further comprising receiving a voice trigger input via a voice trigger input icon in the first web application interface.

12. The method of claim 8, wherein the first action and the second action are not visible on the first web application interface.

13. The method of claim 8, wherein the first action executes a web application.

14. The method of claim 8, wherein the first action executes a search of the second web application interface.

15. A computer-implemented method comprising:
providing a web portal configured to provide access to one or more web applications via one or more hyperlinks each corresponding to one of the one or more web applications, wherein at least one of the one or more hyperlinks is a hidden hyperlink having no visible and selectable representation displayed on the web portal;
receiving an audio command stream, the audio command stream being an audio recording of a user command to access the hidden hyperlink;
querying a command database for at least one word of a command transcription of the user command, the command database including a plurality of commands each associated with one or more command words and each associated with an action;
matching the at least one word of the user command with a command word of the one or more command words associated with a command of the plurality of commands; and
based on the matching of the at least one word of the user command with the command word of the one or more command words, executing an action associated with the command, wherein the action is to select the hidden hyperlink to access the corresponding web application of the one or more web applications,
wherein the method is performed using one or more processors.

16. The method of claim 15 further comprising receiving a list of the plurality of commands and storing the list in the command database.

17. The method of claim 15 further comprising receiving a voice trigger input via a voice trigger input icon in the web portal.

18. The method of claim 15, wherein the action associated with the command is not visible on the web portal.

19. The method of claim 15, wherein the executed action is in a web application of the one or more web applications.

20. The method of claim 15, wherein the executed action is in the web portal.
